(19) United States
(12) Patent Application Publication
(10) Pub. No.: US 2024/0372483 A1
(43) Pub. Date: Nov. 7, 2024

(54) A MULTI-LEVEL POWER CONVERTOR, A MULTI-PHASE POWER CONVERTING CIRCUIT AND A METHOD FOR A MULTI-LEVEL POWER CONVERTOR

(71) Applicant: ABB E-mobility B.V., Delft (NL)

(72) Inventors: Fu Yang, Shenzhen (CN); Yaming Shi, Shenzhen (CN)

(21) Appl. No.: 18/552,864

(22) PCT Filed: Mar. 30, 2021
(86) PCT No.: PCT/CN2021/084056

§ 371 Date: Sep. 27, 2023

(51) Int. Cl. H02M 7/487; H02M 1/00; H02M 7/493

(52) U.S. Cl. CPC H02M 7/487; H02M 1/0043; H02M 1/0064; H02M 7/493

(57) ABSTRACT

A multi-level power convertor is provided. The multi-level power convertor includes a DC port, an AC port, a first power converting unit coupled to the DC port and including a first AC terminal adapted to provide a first plurality of voltage levels, a second power converting unit coupled to the DC port and including a second AC terminal adapted to provide a second plurality of voltage levels of the same number as the first plurality of voltage levels, a coupling inductor including first and second windings with the same number of turns, and an inductive filtering unit arranged between the AC port and the second and fourth ends of the first and second windings.

### CROSS REFERENCE TO RELATED APPLICATIONS

This patent application is a National Stage Entry of PCT/CN2021/084056 filed on Mar. 30, 2021, the disclosure of which is incorporated by reference herein in its entirety as part of the present application.

### BACKGROUND

Embodiments of present disclosure generally relate to the field of power convertors, and more particularly, to a multi-level power convertor, a multi-phase power converting circuit, and a method for a multi-level power convertor.

Currently, power converters are widely used in various fields, which can effectively decrease the switching frequency and improve the output waveform quality. During the use of the power converters, it is desirable to increase the number of the voltage levels to expand the scope of usage of the power converters. Moreover, there is need for a solution for improving the performance and reliability of the multi-level power convertor.

### BRIEF DESCRIPTION

Various example embodiments of the present disclosure provide a multi-level power convertor and a method for a multi-level power convertor so as to improve the performance and reliability of the multi-level power convertor.

In a first aspect of the present disclosure, example embodiments of the present disclosure provide a multi-level power convertor. The multi-level power convertor includes a DC port, an AC port, a first power converting unit coupled to the DC port and including a first AC terminal adapted to provide a first plurality of voltage levels, a second power converting unit coupled to the DC port and including a second AC terminal adapted to provide a second plurality of voltage levels of the same number as the first plurality of voltage levels, the second plurality of voltage levels are phase-shifted by 180 degrees with respect to the first plurality of voltage levels, a coupling inductor including first and second windings with the same number of turns, the first winding includes a first end coupled to the first AC terminal and a second end, the second winding includes a third end coupled to the second AC terminal and a fourth end, and the second end of the first winding and the third end of the second winding are namesake ends of the first and second windings, and an inductive filtering unit arranged between the AC port and the second and fourth ends of the first and second windings.

According to various embodiments of the present disclosure, the multi-level power convertor may generate the desired number of voltage levels using fewer capacitors, reducing the risk of voltage imbalance among the capacitors in the multi-level power convertor and thereby avoiding the damage of the switching semiconductor devices in the multi-level power convertor. Hence, the performance and reliability of the multi-level power convertor may be improved.

In some embodiments, the DC port includes first and second DC terminals, and the first power converting unit includes first and second capacitors connected in series between the first and second DC terminals, first, second, third, and fourth switching semiconductor devices connected in series between the first and second DC terminals, a first node between the first and second capacitors is connected to a second node between the second and third switching semiconductor devices, a fifth switching semiconductor device connected between a third node and the first AC terminal, the third node being between the first and second switching semiconductor devices, and a sixth switching semiconductor device connected between a fourth node and the first AC terminal, the fourth node being between the third and fourth switching semiconductor devices. With these embodiments, the voltage levels provided by the first AC terminal can meet the requirements in a straightforward manner.

In some embodiments, the second power converting unit includes the first and second capacitors shared with the first power converting unit, the first, second, third, and fourth switching semiconductor devices shared with the first power converting unit, a seventh switching semiconductor device connected between the third node and the second AC terminal, and an eighth switching semiconductor device connected between the fourth node and the second AC terminal. With these embodiments, the voltage levels provided by the second AC terminal can meet the requirements in a straightforward manner.

In some embodiments, the second power converting unit includes the first and second capacitors shared with the first power converting unit, ninth, tenth, eleventh, and twelfth switching semiconductor devices connected in series between the first and second DC terminals, a fifth node between the tenth and eleventh switching semiconductor devices is connected to the first node, a thirteenth switching semiconductor device connected between a sixth node and the second AC terminal, the sixth node being between the ninth and tenth switching semiconductor devices, and a fourteenth switching semiconductor device connected between a seventh node and the second AC terminal, the seventh node being between the eleventh and twelfth switching semiconductor devices. With these embodiments, the power on the first, second, third, and fourth semiconductor devices can be reduced, thus prolonging the service life of the semiconductor devices.

In some embodiments, the second and fourth ends of the first and second windings are coupled to a common node, and the inductive filtering unit includes an inductor arranged between the common node and the AC port. With these embodiments, the voltage levels provided by the coupling inductor can be filtered in a robust manner.

In some embodiments, the inductive filtering unit includes a first inductor arranged between the second end of the first winding and the AC port, and a second inductor arranged between the fourth end of second winding and the AC port. With these embodiments, the inductive filtering unit can be implemented in a cost-effective manner.

In some embodiments, the inductive filtering unit includes an additional coupling inductor including third and fourth windings, the third winding is arranged between the second end of the first winding and the AC port, the fourth winding is arranged between the fourth end of second winding and the AC port, and namesake ends of the third and fourth windings are connected to the AC port. With these embodiments, the implementation of the inductive filtering unit can be extended to adapt to various usage scenarios.

In some embodiments, each of the first and second AC terminals provides three voltage levels, and the AC port provides five voltage levels. With these embodiments, a power converting converter with five voltage levels can be obtained in an easy and reliable manner.

In some embodiments, the multi-level power convertor operates as an inverter when the DC port is used as an input and the AC port is used as an output, and the multi-level power convertor operates as a rectifier when the AC port is used as an input and the DC port is used as an output. With these embodiments, the converter can be used for different purposes.

In a second aspect of the present disclosure, example embodiments of the present disclosure provide a multi-phase power converting circuit. The multi-phase power converting circuit includes a plurality of phases, each of the plurality of phases includes the multi-level power convertor described above.

In a third aspect of the present disclosure, example embodiments of the present disclosure provide a method for a multi-level power convertor. The multi-level power convertor includes a DC port, an AC port, a first power converting unit coupled to the DC port and including a first AC terminal, a second power converting unit coupled to the DC port and including a second AC terminal a coupling inductor including first and second windings with the same number of turns, the first winding includes a first end coupled to the first AC terminal and a second end, the second winding includes a third end coupled to the second AC terminal and a fourth end, and the second end of the first winding and the third end of the second winding are namesake ends of the first and second windings, and an inductive filtering unit arranged between the AC port and the second and fourth ends of the first and second windings. The method includes providing a first plurality of voltage levels to the first end of the first winding from the first AC terminal providing a second plurality of voltage levels of the same number as the first plurality of voltage levels to the third end of the second winding from the second AC terminal, the second plurality of voltage levels are phase-shifted by 180 degrees with respect to the first plurality of voltage levels, and outputting a third plurality of voltage levels via the second end of the first winding and the fourth end of the second winding, the number of the third plurality of voltage levels equals to the sum of the number of the first plurality of voltage levels and the number of the second plurality of voltage levels minus one.

In some embodiments, the second and fourth ends of the first and second windings are coupled to a common node, and the inductive filtering unit includes an inductor arranged between the common node and the AC port.

In some embodiments, the inductive filtering unit includes a first inductor arranged between the second end of the first winding and the AC port, and a second inductor arranged between the fourth end of second winding and the AC port.

In some embodiments, the inductive filtering unit includes an additional coupling inductor including third and fourth windings, the third winding is arranged between the second end of the first winding and the AC port, the fourth winding is arranged between the fourth end of second winding and the AC port, and namesake ends of the third and fourth windings are connected to the AC port.

### BRIEF DESCRIPTION OF THE DRAWINGS

Through the following detailed descriptions with reference to the accompanying drawings, the above and other features and advantages of the example embodiments disclosed herein will become more comprehensible. In the drawings, several example embodiments disclosed herein will be illustrated in an exemplary and in a non-limiting manner, wherein:

FIG. 1 illustrates a block diagram of a multi-level power convertor in accordance with an embodiment of the present disclosure:

FIG. 2 illustrates a schematic circuit diagram of a multi-level power convertor in accordance with an embodiment of the present disclosure:

FIG. 3 illustrates a schematic circuit diagram of a multi-level power convertor in accordance with another embodiment of the present disclosure:

FIG. 4 illustrates an example arrangement of a coupling inductor and an inductive filtering unit in accordance with an embodiment of the present disclosure:

FIG. 5 illustrates an example arrangement of the coupling inductor and the inductive filtering unit in accordance with another embodiment of the present disclosure;

FIG. 6 illustrates an example arrangement of the coupling inductor and the inductive filtering unit in accordance with yet another embodiment of the present disclosure; and

FIG. 7 illustrates a schematic circuit diagram of a three-phase power converting circuit in accordance with an embodiment of the present disclosure.

Throughout the drawings, the same or similar reference symbols are used to indicate the same or similar elements.

### DETAILED DESCRIPTION

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to”. The term “or” is to be read as “and/or” unless the context clearly indicates otherwise. The term “based on” is to be read as “based at least in part on”. The term “being operable to” is to mean a function, an action, a motion, or a state can be achieved by an operation induced by a user or an external mechanism. The term “one embodiment” and “an embodiment” are to be read as “at least one embodiment”. The term “another embodiment” is to be read as “at least one other embodiment”. The terms “first”, “second”, and the like may refer to different or same objects. Other definitions, explicit and implicit, may be included below. A definition of a term is consistent throughout the description unless the context clearly indicates otherwise.

Unless specified or limited otherwise, the terms “mounted”, “connected”, “supported”, and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar, or corresponding parts in the figures. Other definitions, explicit and implicit, may be included below.

According to embodiments of the present disclosure, to improve the performance and reliability of the multi-level power convertor, the first plurality of voltage levels and the second plurality of voltage levels having a phase shift of 180 degrees may be combined by the coupling inductor, such that the multi-level power convertor in accordance with embodiments of the present disclosure may generate the desired number of voltage levels using fewer capacitors. The above idea may be implemented in various manners, as will be described in detail in the following paragraphs.

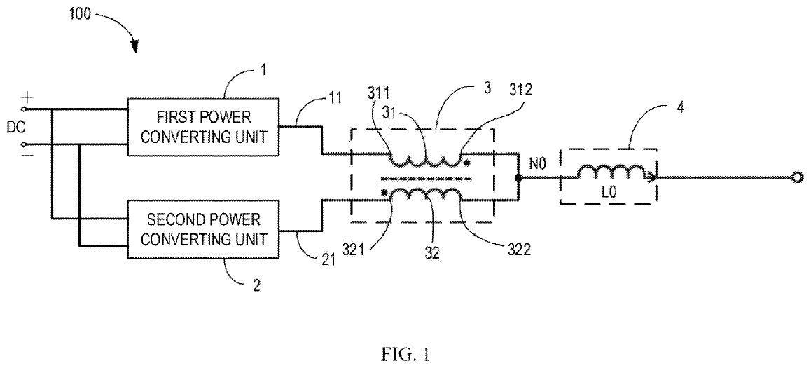

Hereinafter, the principles of the present disclosure will be described hereinafter in detail with reference to FIGS. 1-7. Referring to FIG. 1 first, FIG. 1 illustrates a block diagram of a multi-level power convertor 100 in accordance with an embodiment of the present disclosure. As shown in FIG. 1, the multi-level power convertor 100 generally includes a DC port, an AC port, a first power converting unit 1, a second power converting unit 2, a coupling inductor 3, and an inductive filtering unit 4. The multi-level power convertor 100 may be a bidirectional power convertor. The multi-level power convertor 100 may operate as an inverter when the DC port is used as an input and the AC port is used as an output. Instead, the multi-level power convertor 100 may operate as a rectifier when the AC port is used as an input and the DC port is used as an output.

The DC port includes first and second DC terminals DC+, DC−. The first power converting unit 1 and the second power converting unit 2 are coupled to the DC port respectively. The first power converting unit 1 includes a first AC terminal 11 for providing a first plurality of voltage levels. The second power converting unit 2 includes a second AC terminal 21 for providing a second plurality of voltage levels. The number of the second plurality of voltage levels is the same as the number of the first plurality of voltage levels. The first and second power converting units 1 and 2 have the same switching cycle. In addition, the second plurality of voltage levels are phase-shifted by 180 degrees, i.e., a half of the switching cycle of the first and second power converting units 1 and 2, with respect to the first plurality of voltage levels.

The coupling inductor 3 includes first and second windings 31, 32 with the same number of turns. The first winding 31 includes a first end 311 coupled to the first AC terminal 11 and a second end 312. The second winding 32 includes a third end 321 coupled to the second AC terminal 21 and a fourth end 322. The second end 312 of the first winding 31 and the third end 321 of the second winding 32 are namesake ends of the first and second windings 31, 32. With such an arrangement, the first and second winding 31, 32 may induce voltages of the same magnitude and opposite directions.

With the coupling inductor 3, the first plurality of voltage levels and the second plurality of voltage levels having a phase shift of 180 degrees may be combined into a third plurality of voltage levels. The number of the third plurality of voltage levels would be equal to the sum of the number of the first plurality of voltage levels and the number of the second plurality of voltage levels minus one. If both the number of the first plurality of voltage levels and the second plurality of voltage levels are three, the number of the third plurality of voltage levels would be five.

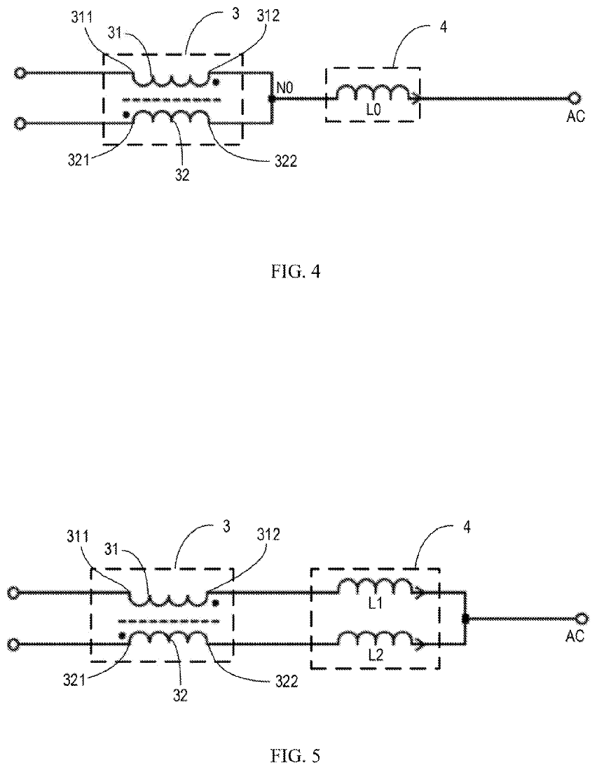

The inductive filtering unit 4 is arranged between the AC port and the coupling inductor 3, so as to filter the third plurality of voltage levels provided by the coupling inductor 3. The coupling inductor 3 and the inductive filtering unit 4 may have various arrangements, which will be described in detail hereinafter with reference to FIGS. 4-6.

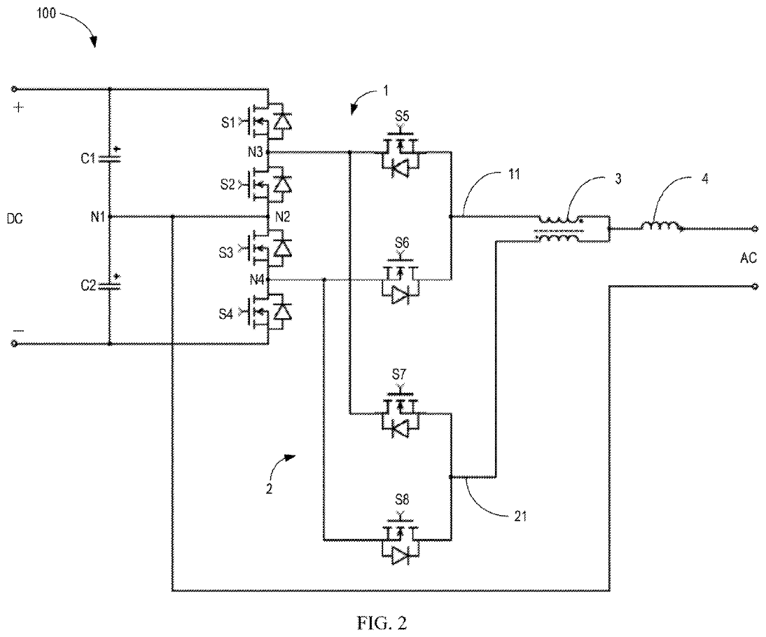

Referring to FIG. 2, which illustrates a schematic circuit diagram of a multi-level power convertor 100 in accordance with an embodiment of the present disclosure.

In the illustrated embodiment, the first power converting unit 1 includes capacitors C1 and C2 and switching semiconductor devices S1, S2, S3, S4, S5, and S6. The capacitors C1 and C2 are connected in series between the first and second DC terminals DC+, DC−. The switching semiconductor devices S1, S2, S3, and S4 may be line frequency switches. The switching semiconductor devices S1, S2, S3, and S4 are connected in series between the first and second DC terminals DC+, DC−. A first node N1 between the capacitors C1 and C2 is connected to a second node N2 between the switching semiconductor devices S2 and S3. The node N1 may be used as a reference voltage point of the AC port. The switching semiconductor devices S5 and S6 may be high frequency switches and have the same switching cycle. The switching semiconductor device S5 is connected between a third node N3 and the first AC terminal 11. The third node N3 is between the switching semiconductor devices S1 and S2. The switching semiconductor device S6 is connected between a fourth node N4 and the first AC terminal 11. The fourth node N4 is between the switching semiconductor devices S3 and S4.

The switching semiconductor devices S5 and S6 are complementary switches. That is, when the switching semiconductor device S5 is switched on, the switching semiconductor device S6 is switched off, and vice versa.

In an embodiment, as shown in FIG. 2, the second power converting unit 2 includes capacitors C1 and C2 and switching semiconductor devices S1, S2, S3, S4, S7, and S8. The capacitors C1 and C2 and the switching semiconductor devices S1, S2, S3, and S4 are shared by the first power converting unit 1 and the second power converting unit 2. The switching semiconductor devices S7 and S8 may be high frequency switches and have the same switching cycle as the switching semiconductor devices S5 and S6. The switching semiconductor device S7 is connected between the third node N3 and the second AC terminal 21. The switching semiconductor device S8 is connected between the fourth node N4 and the second AC terminal 21.

The switching semiconductor devices S7 and S8 may be complementary switches. That is, when the switching semiconductor device S7 is switched on, the switching semiconductor device S8 is switched off, and vice versa. A driving signal of the switching semiconductor device S7 may lag a half of the switching cycle than that of the switching semiconductor device S5. A driving signal of the switching semiconductor device S8 may lag a half of the switching cycle than that of the switching semiconductor device S6. Thus, there is a phase shift of 180 degrees between the second plurality of voltage levels and the first plurality of voltage levels.

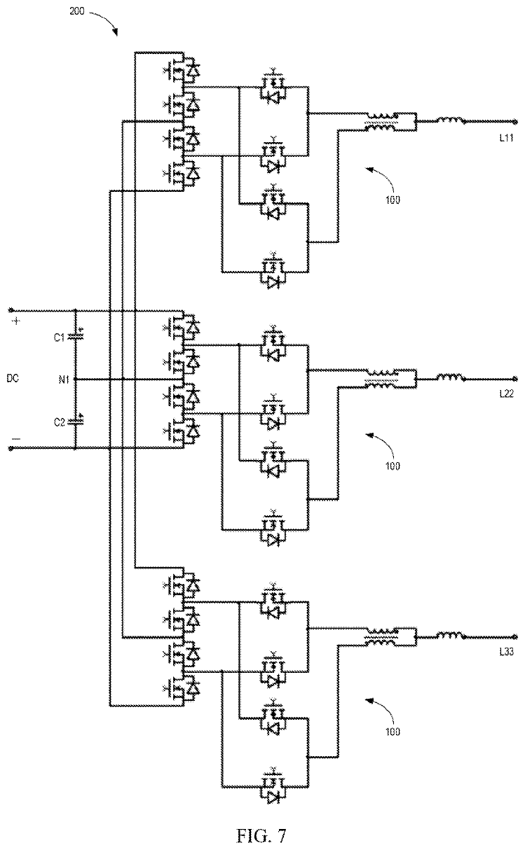

With the above arrangement, each of the first and second power converting units 1, 2 may provide three voltage levels at the respective AC terminals 11, 21. Accordingly, the coupling inductor 3 may provide five voltage levels at the second end 312 of the first winding 31 and the fourth end 322 of the second winding 32. In comparison with the conventional multi-level power convertor 100 as shown in FIG. 1, the multi-level power convertor 100 as shown in FIG. 6 may provide the same number of voltage levels though using fewer capacitors, reducing the risk of voltage imbalance among the capacitors in the multi-level power convertor 100 and thereby avoiding the damage of the switching semiconductor devices in the multi-level power convertor 100.

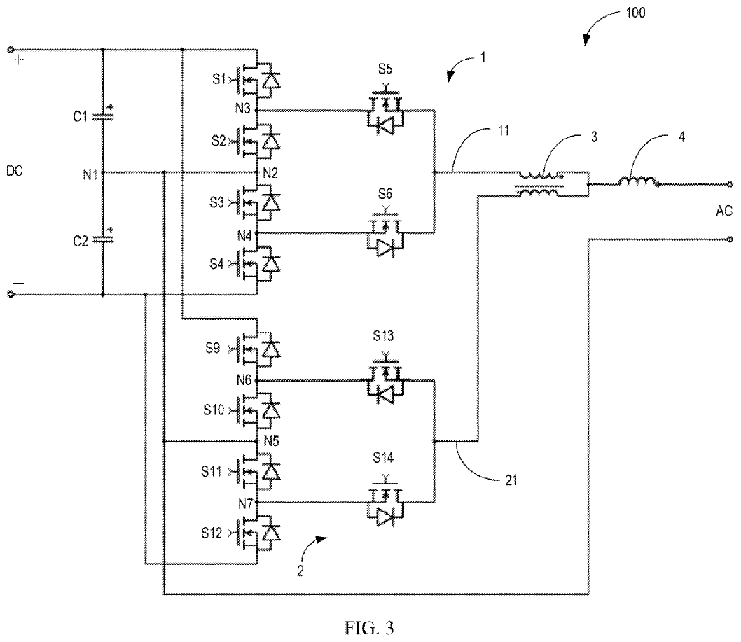

FIG. 3 illustrates a schematic circuit diagram of a multi-level power convertor 100 in accordance with another embodiment of the present disclosure. The construction of the multi-level power convertor 100 as shown in FIG. 3 is similar to that of the multi-level power convertor 100 as shown in FIG. 2. The main difference between the multi-level power convertors 100 as shown in FIGS. 2 and 3 lies in the construction of the second power converting units 2.

As shown in FIG. 3, the second power converting unit 2 includes capacitors C1, C2, and C4 and switching semiconductor devices S9, S10, S11, S12, S13, and S14. The switching semiconductor devices S9, S10, S11, and S12 may be line frequency switches. The switching semiconductor devices S13 and S14 may be high frequency switches. The capacitors C1 and C2 are shared by the first power converting unit 1 and the second power converting unit 2. The switching semiconductor devices S9, S10, S11, and S12 are connected in series between the first and second DC terminals DC+, DC−. A fifth node N5 between the switching semiconductor devices S10 and S11 is connected to the first node N1. The switching semiconductor device S13 is connected between a sixth node N6 and the second AC terminal 21. The sixth node N6 is between the switching semiconductor devices S9 and S10. The switching semiconductor device S14 is connected between a seventh node N7 and the second AC terminal 21. The seventh node N7 is between the switching semiconductor devices S11 and S12.

With the above arrangements, the operation of the multi-level power convertor 100 as shown in FIG. 3 is similar to that of the multi-level power convertor 100 as shown in FIG. 2. The provision of the switching semiconductor devices S9, S10, S11, and S12 can reduce the power generated on the switching semiconductor devices S1, S2, S3, and S4. In this way, the switching semiconductor devices can operate with a relatively safe power, thus increasing the lifetime of the switching semiconductor devices.

FIGS. 4-6 illustrate an example arrangement of a coupling inductor and an inductive filtering unit in accordance with various embodiment of the present disclosure, respectively.

In an embodiment, as shown in FIG. 4, the second and fourth ends 312, 322 of the first and second windings 31, 32 are coupled to a common node N0. The inductive filtering unit 4 includes an inductor L0 arranged between the common node N0 and the AC port.

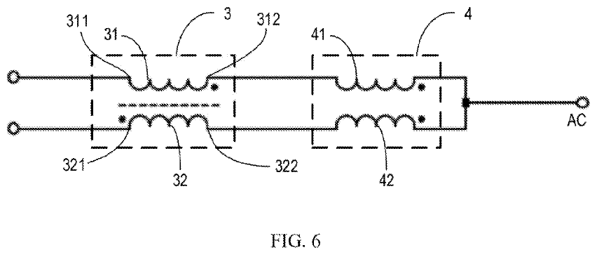

In another embodiment, as shown in FIG. 5, the inductive filtering unit 4 includes a first inductor L1 and a second inductor L2. The first inductor L1 is arranged between the second end 312 of the first winding 31 and the AC port. The second inductor L2 is arranged between the fourth end 322 of second winding 32 and the AC port.

In yet another embodiment, as shown in FIG. 6, the inductive filtering unit 4 includes an additional coupling inductor consisting of third and fourth windings 41, 42. The third winding 41 is arranged between the second end 312 of the first winding 31 and the AC port. The fourth winding 42 is arranged between the fourth end 322 of second winding 32 and the AC port. Namesake ends of the third and fourth windings 41, 42 are connected to the AC port.

Although the coupling inductor 3 and the inductive filtering unit 4 in FIGS. 2 and 3 have the same construction and arrangement as those described with reference to FIG. 4, it is to be understood that the coupling inductor 3 and the inductive filtering unit 4 in FIGS. 2 and 3 may have other constructions and arrangements, for example those as described above with reference to FIGS. 5 and 6. The scope of the present disclosure is not intended to be limited in this respect.

Each of the multi-level power convertors 100 as described with reference to FIGS. 1-6 is a single-phase circuit. However, in other embodiments, each of the multi-level power convertors 100 may be used to form a three-phase circuit.

FIG. 7 illustrates a schematic circuit diagram of a three-phase power converting circuit 200 in accordance with an embodiment of the present disclosure. As shown, the three-phase power converting circuit 200 includes three phases L11, L22, and L33. Each of the phases L11, L22, and L33 includes the multi-level power convertor 100 as described above with reference to FIG. 6. In other embodiments, each of the phases L11, L22, and L33 may include the multi-level power convertor 100 according to other embodiments. It is to be understood that the three-phase power converting circuit 200 is merely schematic and the number of the phases can be adjusted according to the actual need, such as two, four, or even more.

In embodiments according to the present disclosure, the switching semiconductor devices in the first and second power converting units 1, 2 may be of various types, for example MOSFET, IGBT, and the like. The scope of the present disclosure is not intended to be limited in this respect.

In some embodiments, a method for the multi-level power convertor 100 as described above is provided. The method includes providing a first plurality of voltage levels to the first end 311 of the first winding 31 from the first AC terminal 11, providing a second plurality of voltage levels of the same number as the first plurality of voltage levels to the third end 321 of the second winding 32 from the second AC terminal 21, wherein the second plurality of voltage levels are phase-shifted by 180 degrees with respect to the first plurality of voltage levels, and outputting a third plurality of voltage levels via the second end 312 of the first winding 31 and the fourth end 322 of the second winding 32, wherein the number of the third plurality of voltage levels equals to the sum of the number of the first plurality of voltage levels and the number of the second plurality of voltage levels minus one.

According to various embodiments of the present disclosure, the first plurality of voltage levels and the second plurality of voltage levels having a phase shift of 180 degrees may be combined by the coupling inductor 3 into a third plurality of voltage levels. The number of the third plurality of voltage levels equals to the sum of the number of the first plurality of voltage levels and the number of the second plurality of voltage levels minus one. In this way, the multi-level power convertor 100 in accordance with embodiments of the present disclosure may generate the same number of voltage levels as the conventional multi-level power convertor though using fewer capacitors, reducing the risk of voltage imbalance among the capacitors in the multi-level power convertor 100 and thereby avoiding the damage of the switching semiconductor devices in the multi-level power convertor 100. Hence, the performance and reliability of the multi-level power convertor 100 may be improved.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A multi-level power convertor comprising:
a DC port:
an AC port:
a first power converting unit coupled to the DC port and comprising a first AC terminal adapted to provide a first plurality of voltage levels;
a second power converting unit coupled to the DC port and comprising a second AC terminal adapted to provide a second plurality of voltage levels of the same number as the first plurality of voltage levels, wherein the second plurality of voltage levels are phase-shifted by 180 degrees with respect to the first plurality of voltage levels;
a coupling inductor comprising first and second windings with the same number of turns, wherein the first winding comprises a first end coupled to the first AC terminal and a second end, wherein the second winding comprises a third end coupled to the second AC terminal and a fourth end and wherein the second end of the first winding and the third end of the second winding are namesake ends of the first and second windings; and
an inductive filtering unit arranged between the AC port and the second and fourth ends of the first and second windings.

2. The multi-level power convertor according to claim 1, wherein the DC port comprises first and second DC terminals, and wherein the first power converting unit comprises:
first and second capacitors connected in series between the first and the second DC terminals;
first, second, third, and fourth switching semiconductor devices connected in series between the first and second DC terminals, wherein a first node between the first and second capacitors is connected to a second node between the second and third switching semiconductor devices;
a fifth switching semiconductor device connected between a third node and the first AC terminal, the third node being between the first and second switching semiconductor devices; and
a sixth switching semiconductor device connected between a fourth node and the first AC terminal, the fourth node being between the third and fourth switching semiconductor devices.

3. The multi-level power convertor according to claim 2, wherein the second power converting unit comprises:
the first and second capacitors shared with the first power converting unit;
the first, second, third, and fourth switching semiconductor devices shared with the first power converting unit;
a seventh switching semiconductor device connected between the third node and the second AC terminal; and
an eighth switching semiconductor device connected between the fourth node and the second AC terminal.

4. The multi-level power convertor according to claim 2, wherein the second power converting unit comprises:
the first and second capacitors shared with the first power converting unit;
ninth, tenth, eleventh, and twelfth switching semiconductor devices connected in series between the first and second DC terminals, wherein a fifth node between the tenth and eleventh switching semiconductor devices is connected to the first node;
a thirteenth switching semiconductor device connected between a sixth node and the second AC terminal, the sixth node being between the ninth and tenth switching semiconductor devices; and
a fourteenth switching semiconductor device connected between a seventh node and the second AC terminal, the seventh node being between the eleventh and twelfth switching semiconductor devices.

5. The multi-level power convertor according to claim 1, wherein the second and fourth ends of the first and second windings are coupled to a common node, and wherein the inductive filtering unit comprises an inductor arranged between the common node and the AC port.

6. The multi-level power convertor according to claim 1, wherein the inductive filtering unit comprises:
a first inductor arranged between the second end of the first winding and the AC port; and
a second inductor arranged between the fourth end of the second winding and the AC port.

7. The multi-level power convertor according to claim 1, wherein the inductive filtering unit comprises an additional coupling inductor comprising third and fourth windings,
wherein the third winding is arranged between the second end of the first winding and the AC port,
wherein the fourth winding is arranged between the fourth end of the second winding and the AC port, and
wherein namesake ends of the third and fourth windings are connected to the AC port.

8. The multi-level power convertor according to claim 1, wherein each of the first and second AC terminals provides three voltage levels and the AC port provides five voltage levels.

9. The multi-level power convertor according to claim 1, wherein the multi-level power convertor operates as an inverter when the DC port is used as an input and the AC port is used as an output, and
wherein the multi-level power convertor operates as a rectifier when the AC port is used as an input and the DC port is used as an output.

10. A multi-phase power converting circuit comprising a plurality of phases, wherein each of the plurality of phases comprises the multi-level power convertor according to claim 1.

11. A method for a multi-level power convertor, the multi-level power convertor comprising a DC port, an AC port, a first power converting unit coupled to the DC port and comprising a first AC terminal, a second power converting unit coupled to the DC port and comprising a second AC terminal, a coupling inductor comprising first and second windings with the same number of turns, wherein the first winding comprises a first end coupled to the first AC terminal and a second end, the second winding comprises a third end coupled to the second AC terminal and a fourth end, and the second end of the first winding and the third end of the second winding are namesake ends of the first and second windings, and an inductive filtering unit arranged between the AC port and the second and fourth ends of the first and second windings,
the method comprising:
providing a first plurality of voltage levels to the first end of the first winding from the first AC terminal;
providing a second plurality of voltage levels of the same number as the first plurality of voltage levels to the third end of the second winding from the second AC terminal, wherein the second plurality of voltage levels are phase-shifted by 180 degrees with respect to the first plurality of voltage levels; and
outputting a third plurality of voltage levels via the second end of the first winding and the fourth end of the second winding, wherein a number of the third plurality of voltage levels equals to a sum of a number of the first plurality of voltage levels and a number of the second plurality of voltage levels minus one.

12. The method according to claim 11, wherein the second and the fourth ends of the first and second windings are coupled to a common node, and wherein the inductive filtering unit comprises an inductor arranged between the common node and the AC port.

13. The method according to claim 11, wherein the inductive filtering unit comprises:
a first inductor arranged between the second end of the first winding and the AC port; and
a second inductor arranged between the fourth end of the second winding and the AC port.

14. The method according to claim 11, wherein the inductive filtering unit comprises an additional coupling inductor comprising third and fourth windings,
wherein the third winding is arranged between the second end of the first winding and the AC port,
wherein the fourth winding is arranged between the fourth end of the second winding and the AC port, and
wherein namesake ends of the third and fourth windings are connected to the AC port.
